(19) United States
(12) Patent Application Publication
(10) Pub. No.: US 2007/0179239 A1
(43) Pub. Date: Aug. 2, 2007

(54) Dynamic optical components based on thermochromic materials

(75) Inventor: Ming Li, Chelmsford, MA (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/342,486

(22) Filed: Jan. 30, 2006

(51) Int. Cl. G01J 3/50; H01J 5/16; C08K 3/22

(52) U.S. Cl. 524/497; 250/226

(57) ABSTRACT

A dynamic optical device including: a substantially transmissive substrate with a dynamic material surface; a layer of thermochromic (TC) material formed on at least a portion of the dynamic material surface of the substrate; and a heating means thermally coupled to the layer of TC material to controllably vary a temperature of the layer of TC material. The TC material has a first temperature dependent state, which the TC material is in when the temperature of the layer of TC material is less than a transition temperature of the TC material, and a second temperature dependent state, which the TC material is in when the temperature of the layer of TC material is greater than the transition temperature.

### FIELD OF THE INVENTION

The present invention concerns dynamic optical components that utilize thermochromic materials. In particular, these optical devices may include filters, apertures, Fresnel zone plates, transmissive gratings, and dynamic masks.

### BACKGROUND OF THE INVENTION

Digital camera equipment is being incorporated in ever smaller packages. To achieve these reduced sizes, often a number of features must be limited or even removed as compared to larger systems. However, users may desire these features. In some cases the desired features may replace existing features that were originally selected by designers, but in other cases the desired optical or other components used in these features may be too large for such a swap, or users may not be willing to exchange features. Therefore, there is a demand for smaller optical components to accompany these digital cameras.

Additionally, energy consumption by mechanical components may prove problematic as space for power supplies is desirably reduced as well. For example, in new surveillance security camera systems, a motor-less camera may be desirable to reduce power demands and avoid design constraints. A lens that has day/night functions and a variable iris may also be desired. To realize these functions, electronically controlled infrared (IR) and neutral (ND) filters are desired. The desired IR filter is an optical device that is transparent in IR wavelengths when no current is applied, but blocks these IR wavelengths when a current is applied to it (or vice versa). The desired ND filter is an optical device that has zero or a low ND value (in visible wavelengths) when no current is applied, and has a high ND value when a current is applied (or vice versa).

Liquid crystal devices (LCD's) may be used as electronically controlled ND filters. One potential problem with an LCD ND filter, however, is that such a device necessarily loses 50% of incident light, which may be undesirable, particularly in low light or high sensitivity applications. Also, because there are multiple interfaces in LCD's, there is a potential for the creation of glare/ghost images that may be a concern.

Another possibility to be used for the desired electronically controlled ND filters may be electrochromic devices. However, electrochromic device typically have a limited dynamic range. This dynamic range may not be a problem in some applications, but in other applications, a large dynamic range may be highly desired.

Films of vanadium oxides, such as VO₂, react to a rise in temperature by undergoing a reversible semiconductor-metal phase transition, which is associated with a structural phase change from monoclinic to tetragonal. This reversible phase transition leads to a significant increase in the reflectivity of the film for wavelengths of light in the infrared.

### SUMMARY OF THE INVENTION

An exemplary embodiment of the present invention is a dynamic optical device including: a substantially transmissive substrate with a dynamic material surface; a layer of thermochromic (TC) material formed on at least a portion of the dynamic material surface of the substrate; and a heating means thermally coupled to the layer of TC material to controllably vary a temperature of the layer of TC material. The TC material has a first temperature dependent state, which the TC material is in when the temperature of the layer of TC material is less than a transition temperature of the TC material, and a second temperature dependent state, which the TC material is in when the temperature of the layer of TC material is greater than the transition temperature.

Another exemplary embodiment of the present invention is a dynamic optical device including: a first substantially transmissive substrate having a first surface and a second surface substantially parallel to the first surface; a second substantially transmissive substrate having a third surface and a fourth surface substantially parallel to the third surface; a layer of TC gel material disposed on between the second surface of the first substrate and the third surface of the second substrate; and a heating means thermally coupled to the layer of TC gel material to controllably vary a temperature of the layer of TC gel material. The second substantially transmissive substrate is arranged such that its third surface is proximate to and substantially parallel to the second surface of the first substantially transmissive substrate. The TC gel material has a first temperature dependent state, which the TC gel material is in when the temperature of the layer of TC gel material is less than a transition temperature of the TC gel material, and a second temperature dependent state, which the TC gel material is in when the temperature of the layer of TC gel material is greater than the transition temperature.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1A is a cut-away side plan drawing, cut along line 1A-1A in FIG. 1B, illustrating an exemplary thermochromic (TC) material based, dynamic filter according to the present invention.

FIG. 1B is a front plan drawing illustrating the exemplary TC material based, dynamic filter of FIG. 1A.

FIG. 2A is a cut-away side plan drawing, cut along line 2A-2A in FIG. 2B, illustrating an exemplary TC material based, dynamic grating according to the present invention.

FIG. 2B is a front plan drawing illustrating the exemplary TC material based, dynamic grating of FIG. 2A.

FIG. 3A is a cut-away side plan drawing, cut along line 3A-3A in FIG. 3B, illustrating an exemplary TC material based, multiple diameter, dynamic aperture according to the present invention.

FIG. 3B is a front plan drawing illustrating the exemplary TC material based, multiple diameter, dynamic aperture of FIG. 3A.

FIG. 4A is a front plan drawing illustrating an exemplary TC material based, multiple pattern, dynamic mask according to the present invention.

FIGS. 4B, 4C, and 4D are front plan drawings illustrating various exemplary patterns of the exemplary TC material based, multiple pattern, dynamic mask of FIG. 4A.

FIG. 5A is a cut-away side plan drawing, cut along line 5A-5A in FIG. 5B, illustrating an exemplary TC material based, dynamic, one dimensional Fresnel zone plate according to the present invention.

FIG. 5B is a front plan drawing illustrating the exemplary TC material based, dynamic, one dimensional Fresnel zone plate of FIG. 5A.

FIG. 6A is a cut-away side plan drawing, cut along line 6A-6A in FIG. 6B, illustrating an exemplary TC material based, dynamic optical device according to the present invention.

FIG. 6B is a front plan drawing illustrating the exemplary TC material based, dynamic optical device of FIG. 6A.

FIGS. 7A and 7B are front plan drawings illustrating exemplary TC material based, dynamic, two dimensional Fresnel zone plates according to the present invention.

FIGS. 8A and 8B are side plan drawings illustrating additional exemplary TC material based, dynamic optical devices according to the present invention.

FIG. 9 is a graph illustrating exemplary reflectance and transmittance spectra of a VO₂ film.

### DETAILED DESCRIPTION OF THE INVENTION

Exemplary embodiments of the present invention include thermochromic (TC) material based, dynamic optical devices, including dynamic IR and ND filters. The TC materials used in these exemplary embodiments may desirably include thermotropic materials in addition to materials with only color changing properties. These exemplary optical devices may be used to provide fast, energy efficient optical components with a large dynamic range and a reduced physical size. Such optical components may be desirable for use in miniature camera and surveillance applications among others.

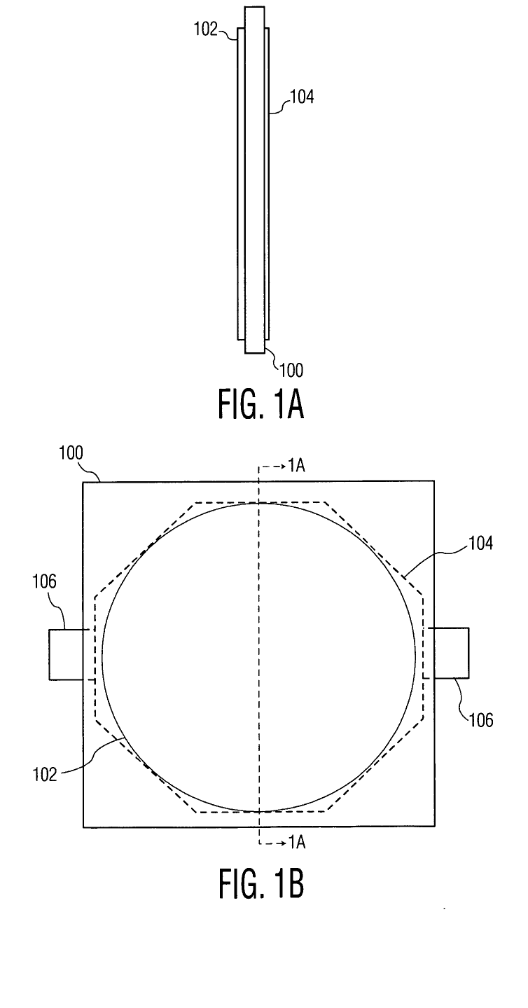

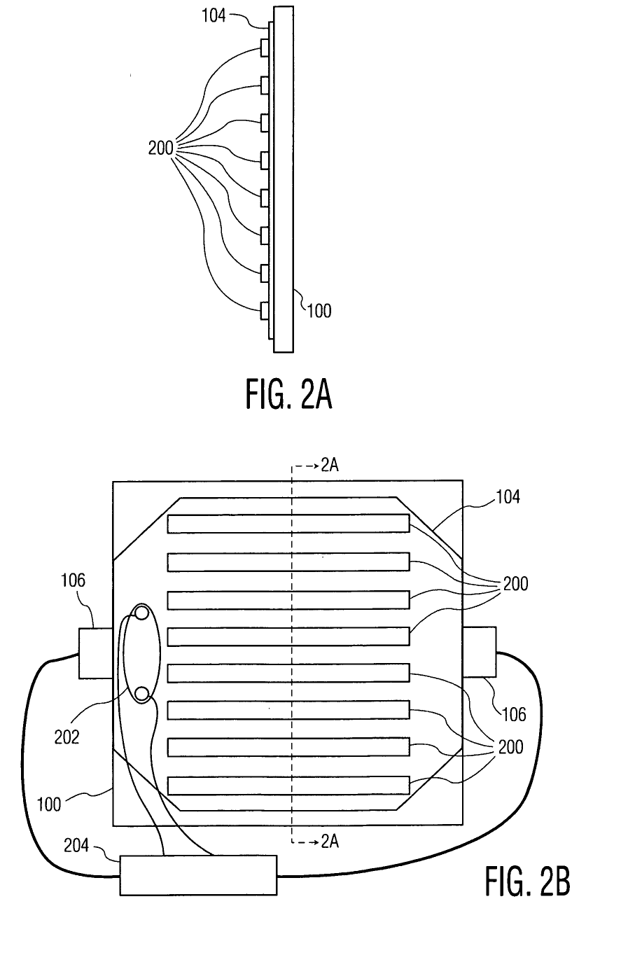

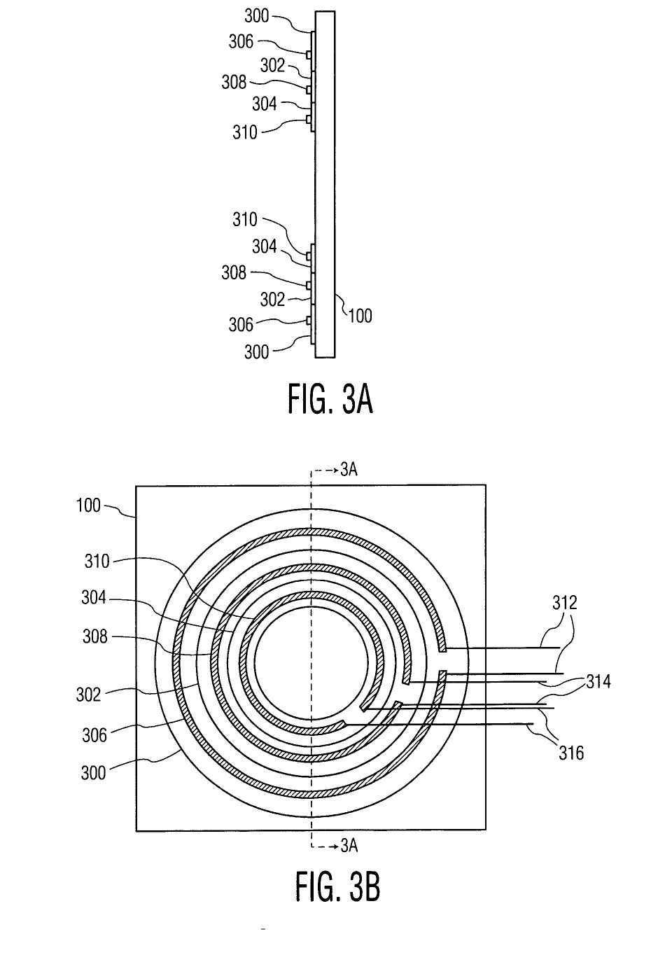

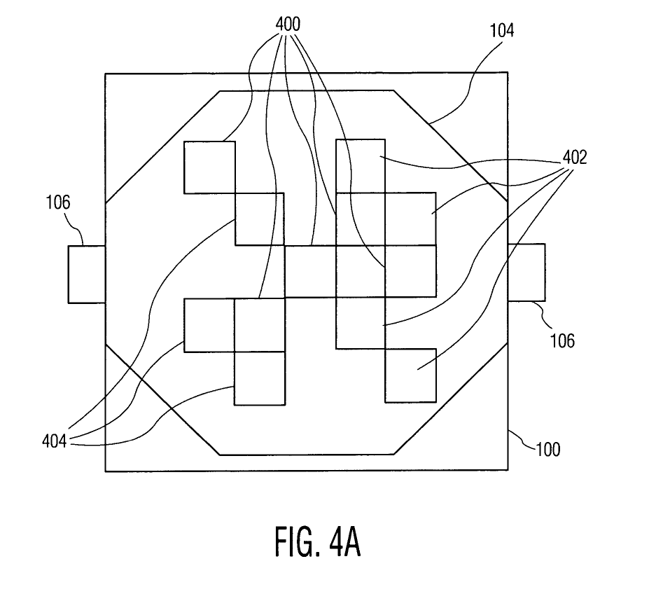

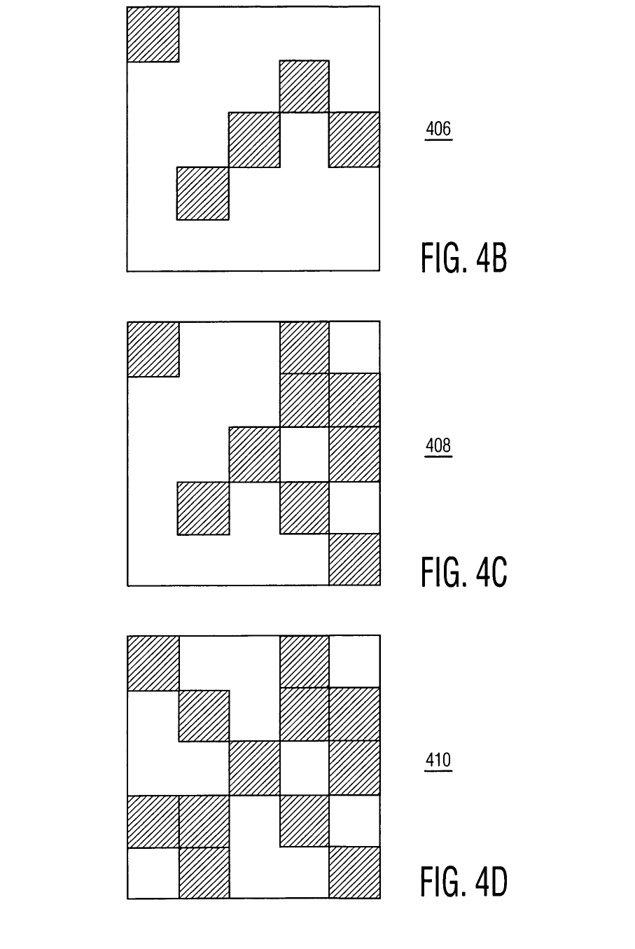

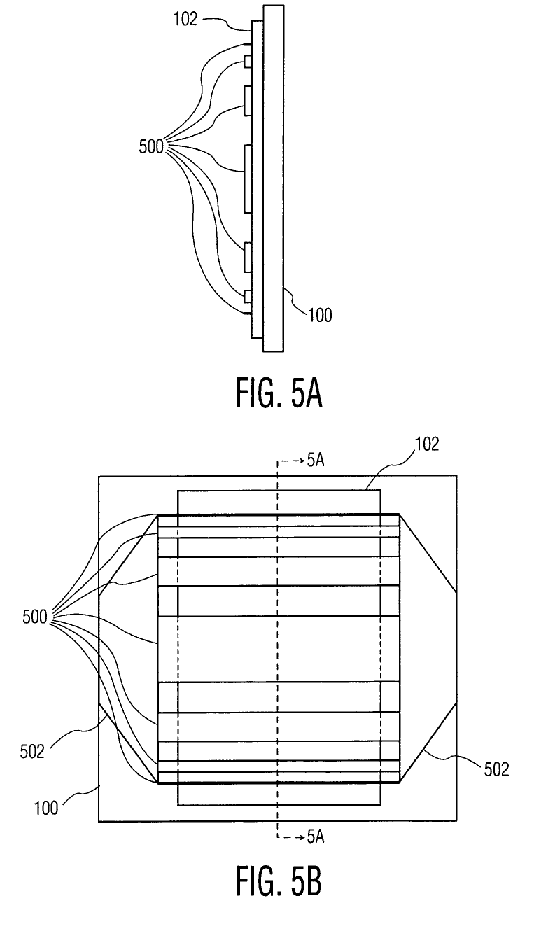

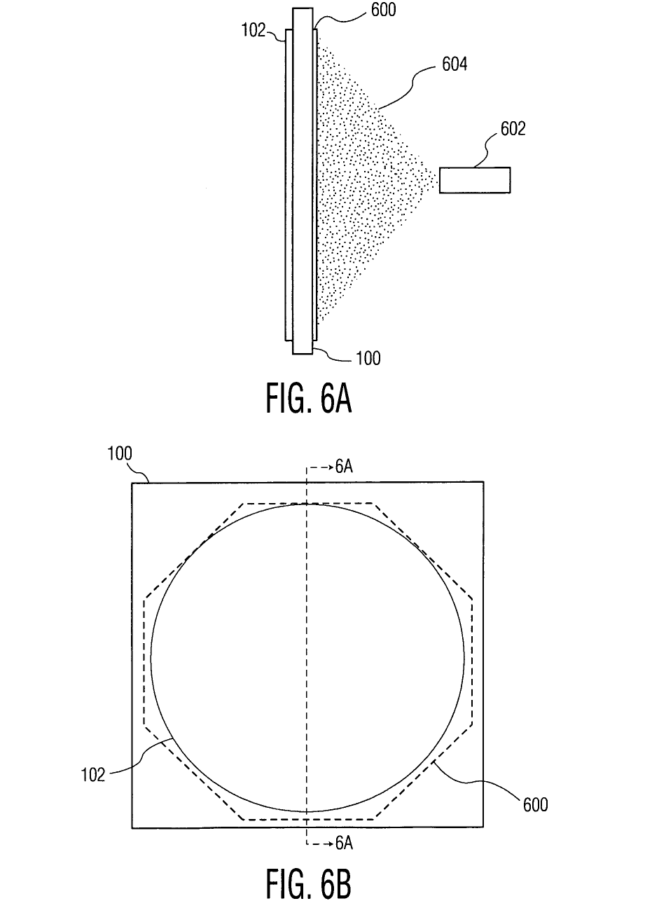

In TC materials, the transmittance of the material changes with the temperature of the material. This property may allow TC materials to be used for active tuning of the transmittance of optical components. For example, FIGS. 1A and 1B illustrate an exemplary TC material based, dynamic filter according to the present invention. The exemplary filter of FIGS. 1A and 1B includes substantially transmissive substrate 100, with layer 102 of TC material formed on a portion of a dynamic material surface. Exemplary dynamic optical devices of the present invention also include a heating means to controllably vary the temperature of the TC material. In the exemplary embodiment of FIGS. 1A and 1B the heating means includes resistive heating element 104 and electrical contacts 106. One skilled in the art will understand that the heating means may be formed: on the opposing surface of substantially transmissive substrate 100, as shown in FIGS. 1A, 1B, 6A and 6B; between substantially transmissive substrate 100 and the layer of TC material, as shown in FIGS. 2A, 2B, and 4A; or on the layer of TC material, as shown in FIGS. 3A, 3B, 5A and 5B.

Substantially transmissive substrate 100 is desirably formed of a standard optical dielectric material such as glass, quartz, fused silica, or sapphire. Depending on the wavelength band for which the dynamic filter is desired other optical materials such as silicon, silicon nitride, germanium, diamond, or various III/V materials may be used for substantially transmissive substrate 100. Substantially transmissive substrate 100 may also be formed of a plurality of layers. For example, substantially transmissive substrate 100 may include an antireflection coating (not shown) formed on its dynamic material surface (the surface on which layer 102 of TC material is formed) and/or its opposing surface to improve transmission of the optical device.

Layer 102 of TC material has a first temperature dependent state and a second temperature dependent state, and substantially covers the operational area of the dynamic material surface of the substrate. Thus, when the TC material is in its first temperature dependent state, the dynamic optical device is substantially transmissive and when the TC material is in its second temperature dependent state, the dynamic optical device is one of a neutral density filter, an infrared filter, or a color filter. The TC material of layer 102 is in its first temperature dependent state when its temperature is less than the transition temperature of the TC material and is in the second temperature dependent state when its temperature is greater than the transition temperature. This exemplary dynamic filter design may be used to create a number of dynamic optical filters based on the type of TC material, such as infrared (IR) filters, neutral density (ND) filters, or color filters.

Exemplary types of TC material that may be used in exemplary embodiments of the present invention include a number of transition metal oxides and related compounds, including Fe₃O₄, FeSi₂, NbO₂, NiS, Ti₂O₃, Ti₄O₇, Ti₅O₉, VO₂, or V₂0₃.

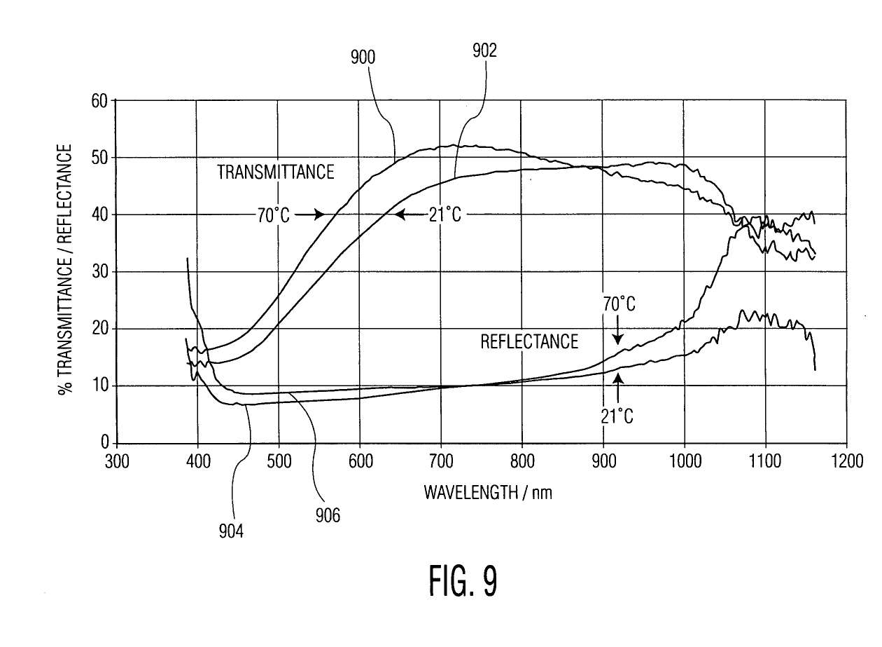

Films of VO₂ react to a rise in temperature by undergoing a reversible semiconductor-metal phase transition, which is associated with a structural phase change from monoclinic to tetragonal crystals. This phase transition leads to a significant increase in reflectivity to wavelengths of light in the infrared, as shown in FIG. 9. The critical transition temperature of VO₂ is about 60° C.-70° C. Spectrum 906 illustrates the reflectance of an exemplary film of VO₂ below the critical transition temperature and spectrum 904 illustrates the reflectance of this exemplary film above the critical transition temperature. Spectra 900 and 902 illustrate the corresponding transmittance of this exemplary film above and below the critical transition temperature, respectively.

The critical transition temperature of VO₂ may be changed by doping the VO₂ with at least one of W, Mo, Nb, or F₂. Using W as the dopant, a transition temperature as low as 30° C. has been reported for VO₂. In most applications, it is desirable that for the transition temperature to be greater than the ambient temperature so that only heating is necessary to switch the TC material between its two states. In many applications, however, the ambient temperature may vary widely. For example, a digital camera may be subjected to temperatures of −20° C. to 40° C., or even greater. Thus, it may be desirable for the transition temperature of TC material to be used in a digital camera application to be 45° C. or greater, even though this selection may lead to longer times for the TC material to switch ‘on’ in colder weather. Alternatively, the temperature of the TC material may be controlled in both states so that a faster switching time may be maintained.

It is noted that a higher transition temperature may allow for quicker cooling in ambient conditions and, thus, faster switching of the TC material from the second state to the first state, while a low transition temperature may require less heating to switch the TC material from the first state to the second state, lowering energy consumption of the exemplary dynamic optical device.

Resistive heating element 104 is desirably formed of a material that has a known resistive characteristic and that is substantially transmissive in the operational wavelength band of the exemplary dynamic optical device. However, it is not necessary for electrical contacts 106 to be substantially transmissive in this band as they are desirably formed outside of the operation area of the exemplary dynamic optical device. Resistive heating element 104 may be formed of a number of materials, including tin oxide, indium-tin oxide, thin metal layers such as gold and calcium, or polyaniline.

It is noted that, although manufacture of the exemplary embodiment shown in FIGS. 1A and 1B may be simplified by forming layer 102 of TC material and resistive heating element 104 on opposing surfaces of substrate 100, this design choice may reduce the speed with which the two states of the TC material may be switched depending on the thermal mass of substrate 100.

FIGS. 2A and 2B illustrate another exemplary optical device according to the present invention, a TC material based, dynamic grating. In this exemplary dynamic grating, resistive heating element 104 has been formed on the dynamic material surface of substantially transmissive substrate 100 and layer 200 of TC material has been formed on resistive heating element 104. TC material layer 200 is patterned such that when the TC material is in its second temperature dependent state, the dynamic optical device becomes a grating. Because when the TC material in its second temperature dependent state both: (i) the transmissivity of the TC material is decreased; and (ii) its reflectivity is increased, this exemplary dynamic grating structure may be used as a dynamic transmissive grating, a dynamic reflective grating, or both.

Also, the heating means of exemplary embodiments of the present invention may desirably include a temperature sensor, shown as thermistor 202 in FIG. 2B, to monitor the temperature of the heating element and/or the TC material layer and control circuitry 204 to maintain the desired temperature. Control circuitry 204 is electrically coupled to the temperature sensor to receive a temperature signal corresponding to a temperature of the TC material layer. The control circuitry then controls the heating element to maintain a desired temperature of the TC material layer. In the case of the exemplary embodiment of FIG. 2B, control circuitry 204 controls the voltage and/or current flowing through resistive heating element 104 providing more or less heat as desired, based on the temperature signal generated by thermistor 202 (i.e. the current passing through thermistor 202 at a constant voltage).

It is noted that, in many applications, fine temperature control is not needed. A transition temperature is selected such that ambient temperature will be significantly (e.g. >10° C.) below the transition temperature and the heating means is set to heat the layer of TC material significantly above the transition temperature. In most other applications, it is only the temperature when the dynamic optical device is ‘on’ (i.e. when the TC material is in its second state) that it is desirable to control. When the device is ‘off,’ the TC material may typically be left at the ambient temperature, however, controlling the temperature of the TC material so that it is near the transition temperature in both states, may allow for quicker switching of the exemplary optical device between off and on, which may be desirable in some applications.

FIGS. 3A and 3B illustrating a further exemplary embodiment of the present invention, an exemplary TC material based, multiple diameter, dynamic aperture. This exemplary multiple diameter, dynamic aperture includes three separate sections of patterned resistive heating elements 306, 308, and 310, electrically coupled to three sets of electrical leads 312, 314, and 316, respectively. This allows the three resistive heating element sections 306, 308, and 310 to be activated independently. Heating resistive heating element section 306 causes section 300 of the TC material layer to switch states and reduce the diameter of the aperture. Likewise, heating resistive heating element section 308 causes section 302 of the TC material layer to switch states and heating resistive heating element section 310 causes section 304 of the TC material layer to switch states. Thus, by heating the various resistive heating element sections three reduced diameter apertures may be formed as well as three annular aperture configurations.

It is noted that section 300, 302, and 304 of TC material in FIGS. 3A and 3B may be formed of a single patterned portion of TC material layer, however these sections may be formed of separate portions of TC material, perhaps portions having different transition temperatures. In the latter case, patterned resistive heating element sections 306, 308, and 310 may be controlled together and the various diameters of the dynamic aperture may be stepped through as the temperature is increased. Although not shown in FIGS. 3A and 3B, one skilled in the art will understand that, if transition of the TC material in sections 306, 308, and 310 is to be precisely controlled spatially, it is desirable for there to be some thermal insulation between these sections. If the substrate material of substantially transmissive substrate 100 is not very thermally conductive, significant thermal isolation of sections 306, 308, and 310 may be achieved by leaving a small separation between the sections. Alternatively, the use of sections formed of TC material having different transition temperatures may be desirable.

FIG. 4A illustrates an exemplary TC material based, multiple pattern, dynamic mask according to the present invention in which various pixels in sections 400, 402, and 404 are formed of TC material having three different transitions temperatures. As discussed above, the transition temperature of some TC materials, such as vanadium oxides, may be controlled through doping. FIGS. 4B-D illustrate the effect of heating this exemplary multiple pattern, dynamic mask through the transition temperatures of the TC materials of sections 400, 402, and 404, which are assumed to be number in temperature order for simplicity. FIG. 4B illustrates exemplary mask pattern 406, formed when the temperature is between the transition temperatures of sections 400 and 402. FIG. 4C illustrates exemplary mask pattern 408, formed when the temperature is between the transition temperatures of sections 402 and 404. And FIG. 4B illustrates exemplary mask pattern 410 formed when the temperature is greater than the transition temperature of section 404.

FIGS. 5A and 5B illustrate an additional exemplary embodiment of the present invention, an exemplary TC material based, dynamic, one dimensional Fresnel zone plate. In this exemplary embodiment, resistive heating element 500 is patterned to be thermally coupled only to predetermined portions of the TC material, such that the dynamic optical device is a dynamic one dimensional Fresnel zone plate. The sections of resistive heating element 500 are desirably electrically coupled together by common electrical contacts 502.

FIGS. 6A and 6B, illustrate yet another exemplary TC material based, dynamic optical device according to the present invention. This exemplary dynamic optical device includes an alternative heating means including dielectric layer 600 and optical source 602. Light 604 is generated by optical source. Dielectric layer 600 is formed of a dielectric material that is substantially transmissive in the operational wavelength band of the dynamic optical device and substantially absorptive at a control wavelength, which is outside of the operational wavelength band. This allows dielectric layer 600 to be heated by irradiation with light 604, which includes the control wavelength. Optical source 602 is desirably a narrow bandwidth optical source such as a laser source, parametric optical amplifier, or light emitting diode (LED) that may generate light at the control wavelength. For example, in an IR filter dielectric layer 600 may be formed of titanium doped sapphire, which is substantially transmissive in the IR, and optical source 602 could be an argon laser or a green LED.

FIGS. 6A and 6B illustrate that dielectric layer 600 extends over the entire operational area of the exemplary dynamic optical device, however, one skilled in the art will understand that dielectric layer 600 may be pattern to heat only predetermined portions of TC material layer 102. Additionally, dielectric layer 600 may be formed on TC material layer 102 or between TC material layer 102 and substrate 100, similar to the resistive heating elements in the embodiments of FIGS. 3A and 2A, respectively. It also is noted that optical source 602 may include optics to control the portion of dielectric layer 600 irradiated with light of the control wavelength such that the dynamic optical device may switch between any of a number of dynamic optical devices, such as a dynamic neutral density filter, a dynamic infrared filter, a dynamic color filter, a dynamic aperture, a dynamic one dimensional Fresnel zone plate, a dynamic two dimensional Fresnel zone plate, a dynamic grating, a dynamic mask, a multiple diameter dynamic aperture, or a multiple pattern dynamic mask.

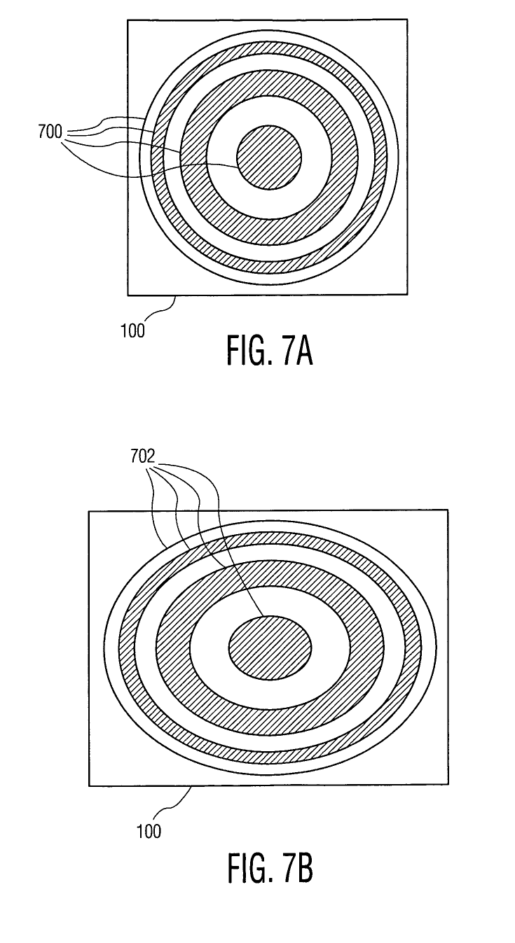

FIGS. 7A and 7B are front plan drawings illustrating exemplary TC material based, dynamic, two dimensional Fresnel zone plates according to the present invention. Dark circular rings 700 and dark elliptical rings 702 may be dynamically switched on and off by selectively heating a layer of TC material. These dark rings of the exemplary dynamic, two dimensional Fresnel zone plates may be formed by patterning the TC material layer, as in the exemplary embodiments of FIGS. 2A, 2B, and 4A; by patterning the heating element, as in the exemplary embodiments of FIGS. 3A, 3B, 5A, and 5B; or by irradiating these portions of a dielectric layer with light of a control wavelength, as in the exemplary embodiments of FIGS. 6A and 6B.

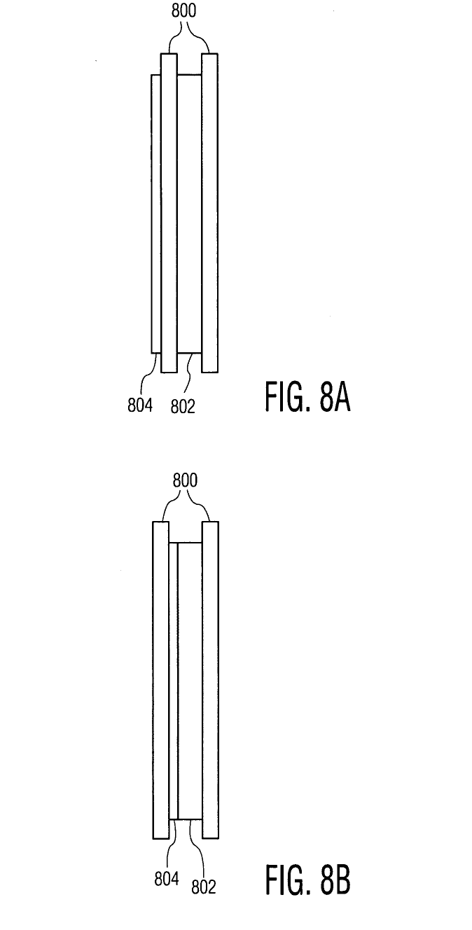

FIGS. 8A and 8B illustrate still further exemplary TC material based, dynamic optical devices according to the present invention. These exemplary dynamic optical devices are based on layer 802 of TC gel material, e.g. a polyether/ethylene oxide/carboxyvinyl hydrogel, disposed on between two substrates 800. As shown in FIGS. 8A and 8B, respectively, heating element 804 may be formed on an outside surface of one of substrates 800 or between an inside surface of on one of substrates 800 and TC gel material 802.

Substrates 800 are desirably arranged such that the inside, gel facing, surfaces of the substrates are proximate to and substantially parallel to each other. Typically, a separation of about 1-10 mm for layer 802 of TC gel material may be sufficient. Substrates 800 are desirably formed of a substantially transmissive optical material such as glass, quartz, fused silica, sapphire or an optical plastic such as acrylic, polyester, polystyrene, polycarbonate, etc. Depending on the wavelength band for which the dynamic filter is desired other optical materials such as silicon, silicon nitride, germanium, diamond, or various III/V materials may be used for substrates 800. Substrates 800 may also be formed of a plurality of layers. For example, these substrates may include an antireflection coating formed on their inner surface(s) and/or their outer surface(s) to improve transmission of the exemplary optical device.

As discussed above with reference to previous exemplary embodiments, heating element 804 may be either a resistive heating element or a dielectric layer that is substantially absorptive at a control wavelength outside of the operational wavelength band of the dynamic optical device. Heating element 804 is shown to cover the entire operational area of the exemplary optical device in FIGS. 8A and 8B and may be used to form a dynamic filter. However, heating element 804 may also be patterned similarly to the exemplary heating elements shown in FIGS. 3A, 3B, 5A, and 5B to allow various exemplary dynamic optical devices to be formed, including dynamic apertures, dynamic one dimensional Fresnel zone plates, dynamic two dimensional Fresnel zone plates, dynamic gratings, dynamic masks, multiple diameter dynamic apertures and multiple pattern dynamic masks.

The present invention includes a number of exemplary TC material based dynamic optical devices. Although the invention is illustrated and described herein with reference to specific embodiments, the invention is not intended to be limited to the details shown. Rather, various modifications may be made in the details within the scope and range of equivalents of the claims and without departing from the invention. In particular, one skilled in the art may understand that many features of the various specifically illustrated embodiments may be mixed to form additional exemplary TC material based dynamic optical devices also embodied by the present invention.

What is claimed:

1. A dynamic optical device, the dynamic optical device comprising:
a substantially transmissive substrate with a dynamic material surface;
a layer of thermochromic (TC) material formed on at least a portion of the dynamic material surface of the substrate, the TC material having a first temperature dependent state and a second temperature dependent state; and
a heating means thermally coupled to the layer of TC material to controllably vary a temperature of the layer of TC material;
wherein the TC material is in the first temperature dependent state when the temperature of the layer of TC material is less than a transition temperature of the TC material and the TC material is in the second temperature dependent state when the temperature of the layer of TC material is greater than the transition temperature.

2. The dynamic optical device according to claim 1, wherein:
the layer of TC material substantially covers an operational area of the dynamic material surface of the substrate;
the dynamic optical device is substantially transmissive when the TC material is in the first temperature dependent state; and
when the TC material is in the second temperature dependent state, the dynamic optical device is one of a neutral density filter, an infrared filter, or a color filter.

3. The dynamic optical device according to claim 1, wherein the layer of TC material is at least one of Fe₃O₄, FeSi₂, NbO₂, NiS, Ti₂O₃, Ti₄O₇, Ti₅O₉, VO₂, or V₂0₃.

4. The dynamic optical device according to claim 1, wherein the layer of TC material is VO₂ doped with at least one of W, Mo, Nb, or F₂.

5. The dynamic optical device according to claim 1, wherein the layer of TC material is patterned such that:
the dynamic optical device is substantially transmissive when the TC material is in the first temperature dependent state; and
when the TC material is in the second temperature dependent state, the dynamic optical device is one of an aperture, a one dimensional Fresnel zone plate, a two dimensional Fresnel zone plate, a grating, or a mask.

6. The dynamic optical device according to claim 1, wherein the layer of TC material includes a plurality of sections, the TC material of each section of the layer of TC material adapted to have a different transition temperature than the TC material of other sections of the layer of TC material.

7. The dynamic optical device according to claim 6, wherein the sections of the layer of TC material are patterned such that the dynamic optical device is one of a multiple diameter dynamic aperture or a multiple pattern dynamic mask.

8. The dynamic optical device according to claim 1, wherein:
the heating means includes a heating element that is substantially transmissive in an operational wavelength band of the dynamic optical device; and
the heating element is formed:
on the layer of TC material;
between the layer of TC material and the dynamic material surface of the substrate; or
on an opposing surface of the substrate substantially parallel to the dynamic material surface of the substrate.

9. The dynamic optical device according to claim 8, wherein the heating element is a resistive heating element formed of at least one of tin oxide, indium-tin oxide, gold, calcium, or polyaniline.

10. The dynamic optical device according to claim 9, wherein the resistive heating element is patterned to be thermally coupled to a predetermined portion of the TC material, such that the dynamic optical device is one of a dynamic aperture, a dynamic one dimensional Fresnel zone plate, a dynamic two dimensional Fresnel zone plate, a dynamic grating, or a dynamic mask.

11. The dynamic optical device according to claim 9, wherein:
the resistive heating element includes a plurality of individually controllable sections; and
each individually controllable section of the resistive heating element is patterned to be thermally coupled to a separate portion of the TC material, such that the dynamic optical device is one of a multiple diameter dynamic aperture or a multiple pattern dynamic mask.

12. The dynamic optical device according to claim 8, wherein:
the heating element is a dielectric layer that is substantially absorptive at a control wavelength outside of the operational wavelength band of the dynamic optical device; and
the heating means further includes an optical source to supply light at the control wavelength to irradiate the dielectric layer.

13. The dynamic optical device according to claim 12, wherein the optical source includes optics to control a portion of the dielectric layer irradiated with the control wavelength such that the dynamic optical device is at least one of a dynamic neutral density filter, a dynamic infrared filter, a dynamic color-filter, a dynamic aperture, a dynamic one dimensional Fresnel zone plate, a dynamic two dimensional Fresnel zone plate, a dynamic grating, a dynamic mask, a multiple diameter dynamic aperture, or a multiple pattern dynamic mask.

14. The dynamic optical device according to claim 8, wherein the heating means further includes:
a temperature sensor thermally coupled to as least one of the heating element or the layer of TC material to monitor the temperature of the layer of TC material and generate a temperature signal corresponding to the monitored temperature; and
control circuitry electrically coupled to the temperature sensor to receive the temperature signal and coupled to the heating element to control the temperature of the layer of TC material.

15. The dynamic optical device according to claim 1, further comprising an antireflection coating formed on at least one of:
the dynamic material surface of the substrate; or
an opposing surface of the substrate substantially parallel to the dynamic material surface of the substrate.

16. A dynamic optical device, the dynamic optical device comprising:
a first substantially transmissive substrate having a first surface and a second surface substantially parallel to the first surface;
a second substantially transmissive substrate having a third surface and a fourth surface substantially parallel to the third surface, the second substantially transmissive substrate arranged such that the third surface of the second substantially transmissive substrate is proximate to and substantially parallel to the second surface of the first substantially transmissive substrate;
a layer of thermochromic (TC) gel material disposed on between the second surface of the first substrate and the third surface of the second substrate, the TC gel material having a first temperature dependent state and a second temperature dependent state; and
a heating means thermally coupled to the layer of TC gel material to controllably vary a temperature of the layer of TC gel material;
wherein the TC gel material is in the first temperature dependent state when the temperature of the layer of TC gel material is less than a transition temperature of the TC gel material and the TC gel material is in the second temperature dependent state when the temperature of the layer of TC gel material is greater than the transition temperature.

17. The dynamic optical device according to claim 16, wherein:
the heating means includes a heating element that is substantially transmissive in an operational wavelength band of the dynamic optical device; and
the heating element is formed on at least one of:
the first surface of the first substrate;
the second surface of the first substrate;
the third surface of the second substrate; or
the fourth surface of the second substrate.

18. The dynamic optical device according to claim 17, wherein:
the heating element substantially covers an operational cross section of the dynamic optical device;
the dynamic optical device is substantially transmissive when the TC gel material is in the first temperature dependent state; and
when the TC gel material is in the second temperature dependent state, the dynamic optical device is one of a neutral density filter, an infrared filter, or a color filter.

19. The dynamic optical device according to claim 17, wherein the heating element is a resistive heating element formed of at least one of tin oxide, indium-tin oxide, gold, calcium, or polyaniline.

20. The dynamic optical device according to claim 19, wherein the resistive heating element is patterned to be thermally coupled to a predetermined portion of the TC gel material, such that the dynamic optical device is one of a dynamic aperture, a dynamic one dimensional Fresnel zone plate, a dynamic two dimensional Fresnel zone plate, a dynamic grating, or a dynamic mask.

21. The dynamic optical device according to claim 19, wherein:
the resistive heating element includes a plurality of individually controllable sections; and
each individually controllable section of the resistive heating element is patterned to be thermally coupled to a separate portion of the TC gel material, such that the dynamic optical device is one of a multiple diameter dynamic aperture or a multiple pattern dynamic mask.

22. The dynamic optical device according to claim 17, wherein:
the heating element is a dielectric layer that is substantially absorptive at a control wavelength outside of the operational wavelength band of the dynamic optical device; and
the heating means further includes an optical source to supply light at the control wavelength to irradiate the dielectric layer.

23. The dynamic optical device according to claim 22, wherein the optical source includes optics to control a portion of the dielectric layer irradiated with the control wavelength such that the dynamic optical device is at least one of a dynamic neutral density filter, a dynamic infrared filter, a dynamic color filter, a dynamic aperture, a dynamic one dimensional Fresnel zone plate, a dynamic two dimensional Fresnel zone plate, a dynamic grating, a dynamic mask, a multiple diameter dynamic aperture, or a multiple pattern dynamic mask.

24. The dynamic optical device according to claim 16, further comprising an antireflection coating formed on at least one of:
the first surface of the first substrate;
the second surface of the first substrate;
the third surface of the second substrate; or
the fourth surface of the second substrate.
